(19) United States
(12) Patent Application Publication
(10) Pub. No.: US 2008/0174110 A1
(43) Pub. Date: Jul. 24, 2008

(54) Elastomer lined, abrasion resistant pipe and method for manufacture

(76) Inventor: John Frederick Olson, Rothschild, WI (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/009,059

(22) Filed: Jan. 16, 2008

Related U.S. Application Data
(60) Provisional application No. 60/881,625, filed on Jan. 22, 2007.

(51) Int. Cl. F16L 9/14; B65H 69/02

(52) U.S. Cl. 285/55; 156/158

(57) ABSTRACT

An abrasive material transferring pipe is lined with a cured shape memory retaining elastomeric liner. The inner surface of the pipe is in contact with the outer surface of the elastomeric liner. When the liner is not under tension, the outer diameter of the elastomeric liner is larger than the inner diameter of the pipe. Expansion pressure by the liner maintains the liner in the pipe.

### CROSS-REFERENCE TO RELATED APPLICATION(S)

This application claims priority from provisional application Ser. No. 60/881,625, filed on Jan. 22, 2007, and entitled “Elastomer Lined, Abrasion Resistant Metallic Pipe and Method of Manufacture,” which is herein incorporated by reference.

### BACKGROUND

This invention relates generally to elastomeric pipe liners. More specifically, the present invention relates to a method of lining a pipe with an elastomeric pipe liner having a greater outer diameter than the inner diameter of the pipe.

Concrete pumps are commonly used on construction projects. A mixer truck usually transports concrete to a site where the concrete pump is located. The concrete is transferred to the hopper of the concrete pump and is pumped to its final location through a system of piping. The system of piping is comprised of many individual pipes coupled together using industry standard flanges on each pipe.

Concrete pumping occurs at high pressures. For example, operating pressures around 1,250 psi are typical. In addition, concrete itself is a very abrasive and damaging material as concrete is typically 0.75% to 1.00% water by weight and 99% rock, stone, sand, cement and fly ash. This creates a harsh environment inside the pipes. An especially harsh environment is created in the deck pipe of pumping trucks where the flow of the concrete is very turbulent.

Currently, ordinary steel pipe or steel pipe treated to harden the inner surface is used for pumping concrete. An ordinary steel pipe has a service life of about 15,000 cubic yards of concrete, and a hardened pipe has a service life of about 35,000 cubic yards of concrete.

Elastomeric materials, such as polyurethanes, have been used for abrasion resistance. For example, pipes made of polyurethane have been used for slurries and pneumatic conveyance of gravel, coal and sand. However, elastomeric materials are very flexible and have a very low pressure capability. For most formulations, the elastomeric pipe starts to balloon up around 40 psi, creating a very dangerous situation.

Elastomeric materials have been used as abrasion resistant coatings in pipes. For example, it has been suggested to protect the inside of pipes with elastomeric liners. The pipe walls support the elastomeric material, allowing the elastomeric material to be used in higher pressure environments. However, these elastomeric lined pipes are impracticable for transferring harsh abrasive materials and an improved pipe is needed.

### SUMMARY

A pipe is lined with a cured shape memory retaining elastomeric liner. The inner surface of the pipe is in contact with the outer surface of the elastomeric liner. When the liner is not under tension, the outer diameter of the elastomeric liner is larger than the inner diameter of the pipe. The liner is inserted into the pipe by elongating the liner so that the outer diameter of the liner is less than the inner diameter of the pipe. When the tension on the liner is reduced, the outer diameter of the liner increases and expansion pressure by the liner maintains the liner in the pipe.

### BRIEF DESCRIPTION OF THE DRAWINGS

FIG. 1 is a side view of the lined pipe of the current invention with a portion broken away to expose the cross-section.

FIG. 2 is a sectional view of the lined pipe taken at line 2-2 of FIG. 1.

FIG. 3 is a sectional view of the lined pipe taken at line 3-3 of FIG. 2.

FIGS. 4a and 4b are sectional views of a pipe.

FIGS. 5a and 5b are sectional views of a cured elastomeric liner.

FIG. 6 is a side view of a tensioning frame.

FIG. 7 is a side view of a liner and a pipe positioned on a tensioning frame.

FIG. 8 is a sectional view of a liner and a tensioner plug.

FIG. 9a is a sectional view of a liner attached to a tensioner plug when no tension is applied to the liner.

FIG. 9b is a sectional view of a liner attached to a tensioner plug when tension is applied to the liner.

FIG. 10 is a side view of a pipe slid over an elongated liner on a tensioning frame.

FIG. 11 is a sectional view of the end of a pipe with a beveled-edge liner.

FIG. 12 is a sectional view of the end of a pipe with a hardened insert meeting a liner at a beveled lap joint.

FIGS. 13a and 13b are side and end views of an adhesive spreader.

### DETAILED DESCRIPTION

Pipes have previously been lined with elastomeric material. In one method, a polyurethane liner is centrifugally cast in a pipe. However, as polyurethane resin cures, it experiences cure shrinkage and shrinks a few percent from it pre-cured size. For example, a 3 m long, 125 mm diameter polyurethane liner cured in-situ will shrink about 63.5 mm in length and about 2.5 mm in diameter. Such liners are acceptable for fluid slurries that have low sheer stress but are impracticable for transferring abrasive materials since the liner, which already is experiencing tension on the steel to urethane bond, will be easily torn out by the shear stress of abrasive material (e.g. concrete) sliding through the pipe.

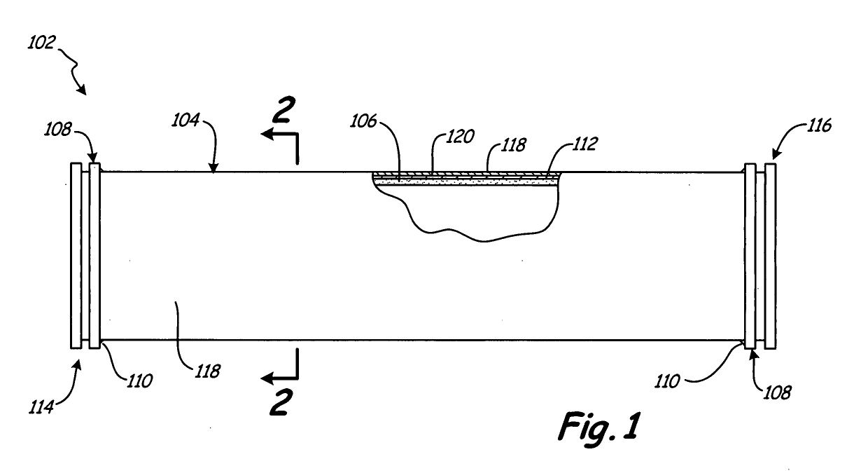

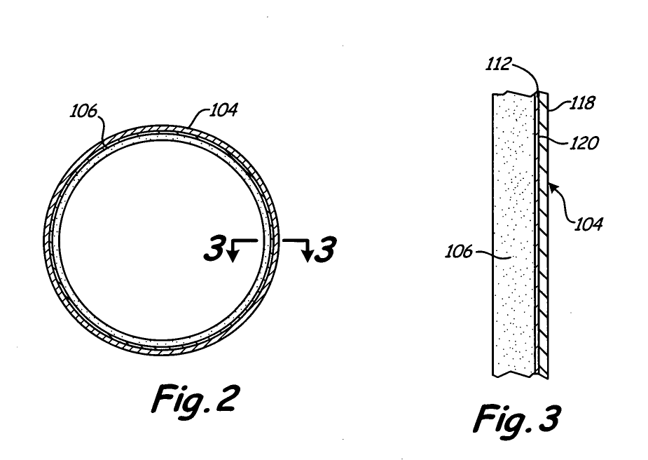

FIG. 1 shows an elastomeric lined pipe 102 for transferring abrasive materials such as concrete being pumped under pressure. FIG. 2 is a cross-sectional view of a line 2-2 of FIG. 1 and FIG. 3 is a cross-sectional view of a line 3-3 of FIG. 2. Elastomeric lined pipe 102 includes pipe 104 (which includes first end 114, second end 116, outer surface 118, and inner surface 120), liner 106, flanges 108, welds 110, and bonding adhesive 112. Flanges 108 are welded onto first end 114 and second end 116 of pipe 104 by welds 110. Liner 106 is located inside of pipe 104 and is in contact with inner surface 120 of pipe 104. The expansion force of liner 106 and bonding adhesive 112 maintain liner 106 inside of pipe 104 when abrasive material with high sheer stress (e.g. concrete) flows through lined pipe 102.

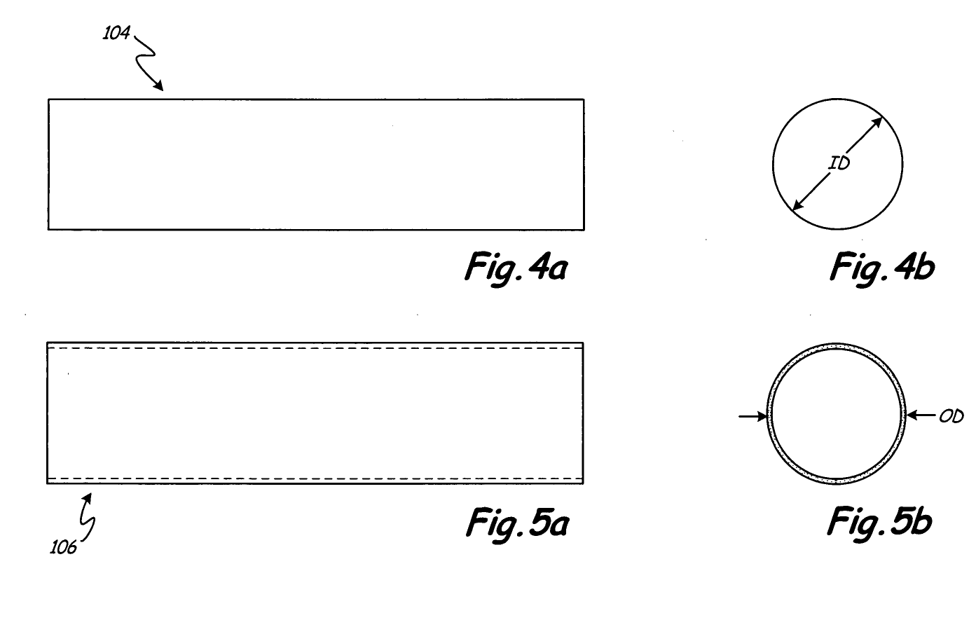

As seen in FIG. 4b, pipe 104 has inner diameter ID; and as seen in FIG. 5b, liner 106 has outer diameter OD. When liner 106 is in an initial untensioned state, inner diameter ID of pipe 104 is less than outer diameter OD of liner 106. In one example, inner diameter ID of pipe 104 is at least about 4.7% smaller than outer diameter OD of liner 106 when liner 106 is not under tension. Pipe 104 may be made of any rigid material. For example, pipe 104 may be steel piping typically used for pumping concrete. Inner diameter ID of pipe 104 depends on the pump attached to pipe 104 since different pumps require different diameter pipes. Inner diameter ID also depends on the pumping conditions. For example, long horizontal pipelines have higher pressures and require a larger diameter pipeline while a smaller diameter pipeline is used for pumping concrete vertically due to the weight of the concrete and the pull of gravity. In one example, inner diameter ID of pipe 104 is between about 100 mm and about 125 mm. Pipe 104 may be of any length. In one example, pipe 104 may be a concrete transferring pipe that is about 3 m long. In another example, pipe 104 may be a slurry transferring pipe that is about 8 m or less in length.

Liner 106 contains a cured elastomeric material, such as polyurethane, that is shape memory retentive. A shape memory retaining material returns to its original shape when a deforming stress is removed. Liner 106 may contain any elastomeric material that is water resistant and that has high acid and base resistances. The liner may have a Die C Tear value greater than about 400 pli, a Split Tear value greater than about 100 pli and/or an elongation value greater than about 400%. In one example, the liner may contain a polyurethane elastomer. The polyurethane elastomer may be formed by mixing a prepolymer with a curative. The prepolymer may be formed from a polytetramethylene ether glycol (PTMEG). Specifically, liner 106 may be formed from the PTMEG product Andur 80-5AP or Andur 2-90AP and cured with the curative Curene 442. The elastomeric properties of Andur 80-5AP and Andur 2-90AP when cured with Curene 442 at 95% stoichiometry are shown in Table 1.

TABLE 1

PTMEG product

| | Andur | Andur |
|---|---|---|
| Elastomeric Properties | 80-5AP | 2-90AP |
| Shore Hardness | 83-85A | 90A |
| Elongation, % | 580 | 470 |
| Die C Tear, pli | 425 | 490 |
| Split Tear, pli | 130 | 110 |
| Compression Set | 28 | 30 |
| Bashore Rebound, % | 55 | 48 |
| Cured Density, g/cc | 1.05 | 1.08 |

Andur 80-5AP and Andur 2-90AP are PTMEG products available from Anderson Development Company, Adrian, Mich. and Curene 442 is a 4,4′-Methylenebis(2-Chlororaniline) (MBOCA) product also available from Anderson Development Company.

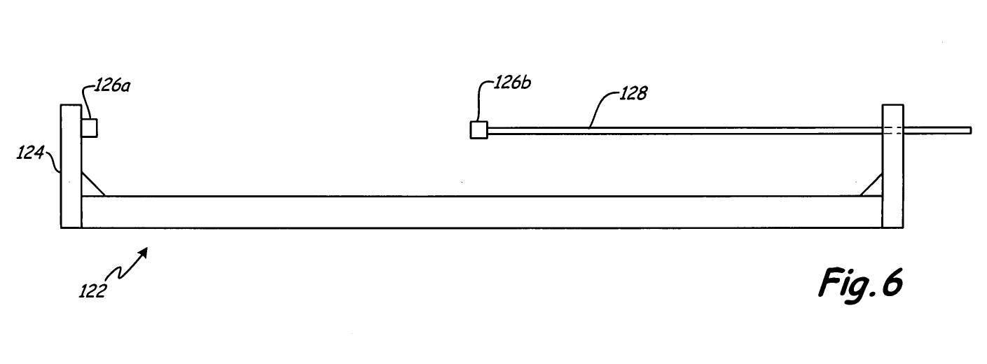

Tensioning frame 122 may be used to reduce outer diameter OD of liner 106 by applying tension force to stretch and elongate liner 106. As seen in FIG. 6, tensioning frame 122 has frame 124, tensioner plugs 126a and 126b, and tensioner member 128. Tensioner plug 126a is attached to frame 124, and tensioner plug 126b is attached to tensioner member 128. Tensioner member 128 extends through frame 124. Tensioner member 128 may be any means to pull tensioner plug 126b. For example tensioner member 128 can be a cable or rope attached to a winch.

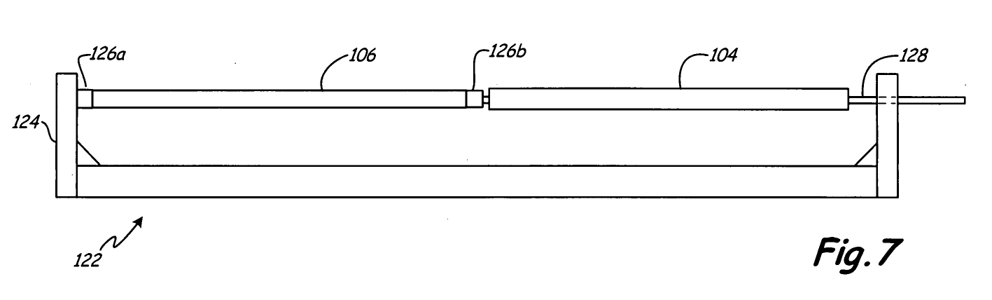

FIG. 7 illustrates how pipe 104 and liner 106 fit on tensioning frame 122. Tensioner member 128 is threaded through pipe 104 and tensioner plug 126b is attached to one end of liner 106. The opposite end of liner 106 is attached to tensioner plug 126a. Tension is applied to liner 106 by pulling on tensioner member 128. When tension is applied, liner 106 is stretched or elongated about its horizontal axis and outer diameter OD of liner 106 is reduced.

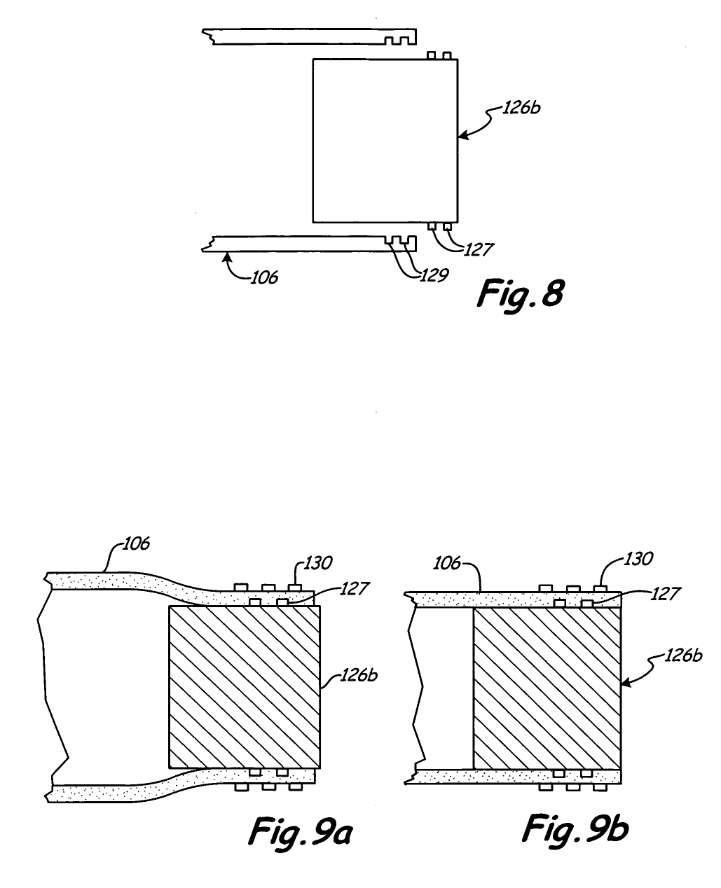

As seen in FIG. 8, tensioner plugs 126a and 126b, which have smaller outer diameters than the inner diameter of liner 106, are inserted into liner 106. For example, tensioner plugs 126a and 126b may have an outer diameter that is about 12.7 mm smaller than the inner diameter of liner 106. Tensioner plug 126b may have two concentric rings 127 that extend from the outer surface of the tensioner plug. Tensioner plug 126a may be similarly formed. Liner 106 may have complementary grooves 129 cut into the inner surface of liner 106 so that rings 127 fit into grooves 129 and provide grip so that tension force may be applied to liner 106.

Tensioner plugs 126a and 126b are held in liner 106 using any means known in the art. For example, hose clamps 130 may be used as illustrated in FIG. 9a. Hose clamp 130 is applied over liner 106 and tightened so that tensioner plug 126b is held in place. This decreases outer diameter OD of liner 106 in the immediate vicinity of hose clamps 30 as seen in FIG. 9a. The outer diameter of tensioner plugs 126a and 126b must be smaller than inner diameter ID of pipe 104. In one example, three hose clamps may be used. In this example, one hose clamp 130 may be placed between rings 127 and the other two hose clamps 130 may be placed on either side of rings 127. Although three hose clamps are shown in the figures, any number of hose clamps may be used to keep liner 106 in place.

FIG. 9b illustrates liner 106 when tension is applied to liner 106 by tensioner member 128 by stretching or elongating liner 106. As can be seen, outer diameter OD is reduced to a uniform diameter the entire length of liner 106.

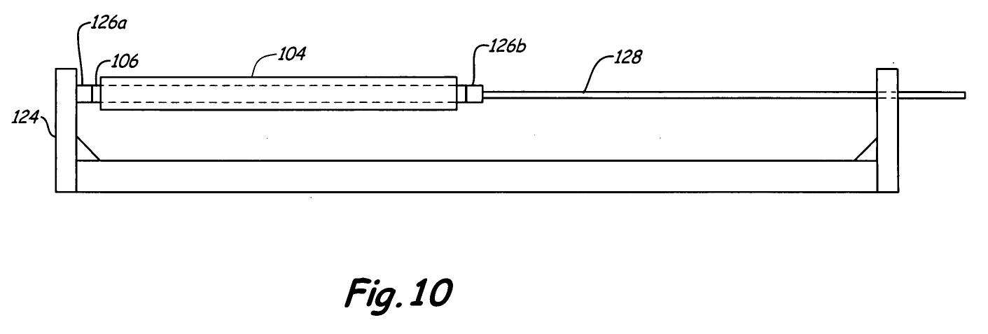

As seen in FIG. 10, after outer diameter OD of liner 106 is reduced so that outer diameter OD is smaller than inner diameter ID of pipe 104 using tensioner member 128, pipe 104 is slid over a central portion of liner 106. Liner 106 should be sized so that when liner 106 is stretched and pipe 104 is in place over liner 106, tensioner plugs 126a and 126b extend from pipe 104 and flanges 108. The tension is then reduced or removed from liner 106 by relaxing the tension force applied to tensioner member 128. In one example, the tension force is relaxed by removing hose clamps 130, by for example grinding hose clamps 130 off. When the tension is reduced or removed from liner 106, liner 106 attempts to return to its shape (i.e. its original length and diameter) because of its shape memory retaining property. Therefore, the ends of liner 106 will recede towards pipe 104 and outer diameter OD will expand and press against inner surface 120 of pipe 104. However, pipe 104 does not allow liner 106 to fully return to its original shape because inner diameter ID is smaller than outer diameter OD. Therefore, liner 106 will continually push against inner surface 120, exerting an expansion force on pipe 104. This expansion force of liner 106 maintains liner 106 in pipe 104 even when abrasive material with high sheer stress is pumped through lined pipe 102.

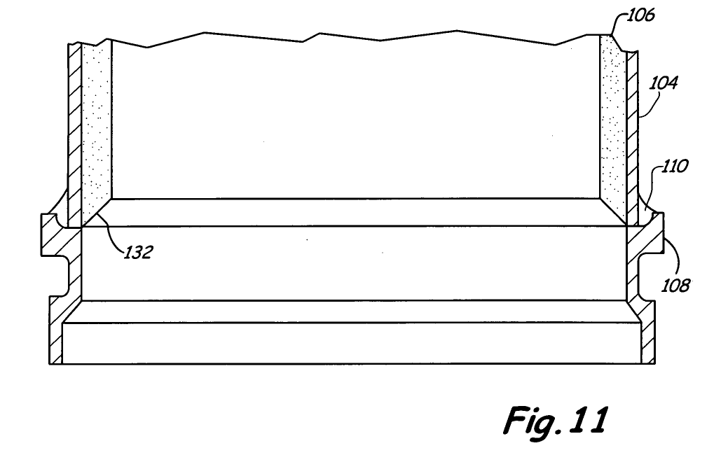

As illustrated in FIG. 11, flanges 108 have an increased inner diameter at the end opposite pipe 104. After the tension has been removed, liner 106 may be longer than pipe 104 and flanges 108. Liner 106 is unable to accommodate the increased diameter of flanges 108 while maintaining the desired expansion force on inner surface 120 of pipe 104. Therefore, liner 106 is trimmed so that it does not extend the full length of flanges 108. For example, the ends of liner 106 may be trimmed with a router so they are approximately even with the ends of pipe 104. Liner 106 may be trimmed to any length so long as liner 106 does not cover the inner surface of flanges 108 where the diameter increases.

A router may also be used to create beveled edge 132 on the ends of liner 106, as seen in FIG. 11. Beveled edge 132 reduces friction in the pipe. For example, when a small rock flowing through lined pipe 102 hits beveled edge 132, the rock flows along the angled edge and is redirected back into the main stream of flow. In contrast, if the edge were at a 90 degree angle, the rock would create a large amount of sheer stress at the edge and eventually rip liner 106 out of pipe 104. Beveled edge 132 may have any angle that is less than 90 degrees. For example, beveled edge 132 may have a 45 degree angle.

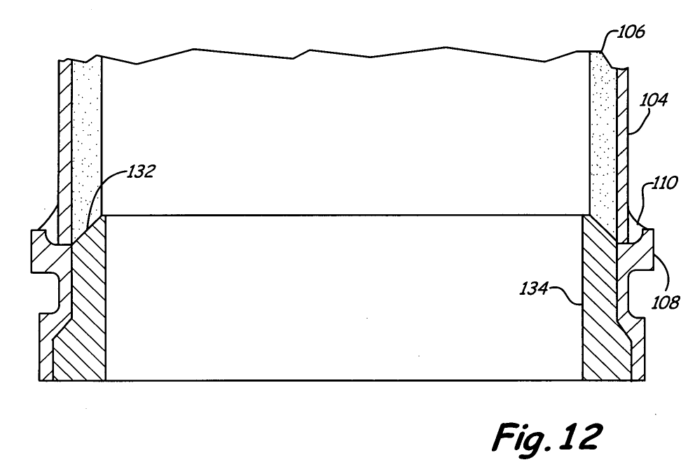

As seen in FIG. 12, beveled-end hardened insert 134 is located inside flange 108. Hardened insert 134 protects the inner surface of flange 108 that is not covered by liner 106 from abrasive material. Hardened insert 134 has a beveled end that is complimentary to beveled edge 132 on liner 106 and meets liner 106 to create a beveled lap joint. Hardened insert 134 is inserted into flange 108 using means known in the art, such as with a hammer or by press-fitting. Hardened insert 134 may contain any material that may be used in abrasive environments. For example, hardened insert 134 may contain steel, ceramic or chromium carbide. Hardened insert 134 will experience wear from the abrasive material. Therefore, hardened insert 134 may have thicker walls than liner 106 to compensate for wear. When hardened insert 134 is worn out, hardened insert 134 may be removed and replaced with a new hardened insert 134.

Pipe 104 must be prepared before placing it on tensioning frame 122. Inner surface 120 of pipe 104 is shot peened. Shot peening cleans inner surface 120, removes mill scale (ferric oxide that forms on the surface of pipes during formation due to the high heat), and creates a slightly rough surface. This assures that liner 106 will bond to pipe 104.

Flanges 108 are welded to first end 114 and second end 116 of pipe 104 at welds 110. Flanges 108 must be welded onto pipe 104 before liner 106 is inserted because the welding heat will affect liner 106.

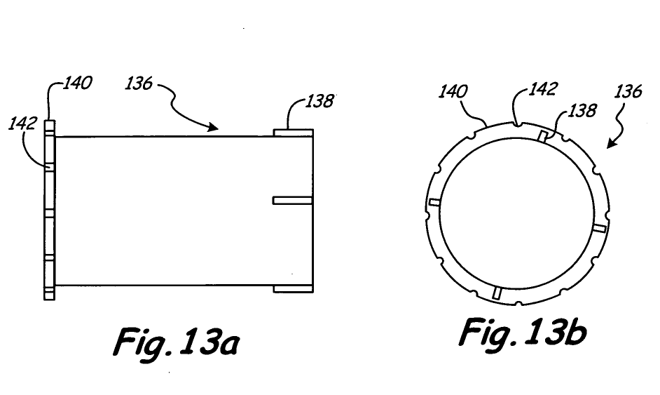

Finally, bonding adhesive 112 is applied to inner surface 120 of pipe 104. Adhesive spreader 136 is used to evenly disperse bonding adhesive 112. Side and end views of adhesive spreader 136 are shown in FIG. 13a and FIG. 13b respectively. Adhesive spreader 136 has centering guides 138 and tail fin 140 with distribution notches 142. Bonding adhesive 112 is applied to inner surface 120 of pipe 104. Then adhesive spreader 136 is drawn through pipe 104. Centering guides 138 assist in centering adhesive spreader 136 in pipe 104. Tail fin 140 is semi-flexible, allowing tail fin 140 to conform to inner surface 120 of pipe 104. Similar to using a grooved trowel on grout, distribution notches 142 leave uniform thickness trails of bonding adhesive on inner surface 120 when adhesive spreader 136 is drawn through pipe 104. In one example, pipe 104 is placed on end, bonding adhesive 112 is poured onto inner surface 120 of pipe 104 and adhesive spreader 136 is drawn through pipe 104. After bonding adhesive 112 is evenly applied to inner surface 120 of pipe 104, pipe 104 is placed on tensioning frame 122 as described above. Bonding adhesive 112 should be selected to provide adequate time to insert liner 106 into pipe 104 before bonding adhesive 112 sets. In one example, a two part epoxy having a 90 minute pot life was used.

Liner 106 must also be prepared before placing it on tensioning frame 122. As discussed above, liner 106 contains a shape memory retaining elastomeric material. For example, polyurethanes may be used. Polyurethanes are very tough, creating an abrasion resistant surface and cure to form a smooth, slippery surface. This smooth surface means that the abrasive material flowing through pipe 104 will encounter less friction in the pipe. This may translate into requiring less pressure to pump the material through the pipe.

Liner 106 may be created using a one-piece tubular mold. First, the tubular mold is polished to create a smooth surface free of any debris and a mold release is applied to the inner surface of the mold. To form the elastomeric material, a prepolymer is mixed with a curing agent in ratios known in the art. In one example, the elastomeric material is a polyurethane and is formed by mixing a prepolymer formed from polytetramethylene ether glycol (PTMEG) such as Andur 80-5AP or Andur 2-90AP with a amine functional or 4,4′-Methylenebis(2-Chlororaniline) (MBOCA) curing agent such as Curene 442, all available from Anderson Development Company, Andur, Mich. In a specific example, Curene 442 in an amount 90% of theoretical equivalent (amino to isocyanate groups) is mixed with Andur 80-5AP. In another example, Curene 442 in an amount 90% of theoretical equivalent is mixed with Andur 2-90AP.

The tubular mold is placed horizontally and a belt drive pulley is placed around the mold. The mold is spun or rotated about its horizontal axis and the prepolymer/curing agent mix is introduced into the mold. The inner diameter and the length of the mold define outer diameter OD and length of liner 106 while the amount of mix introduced into the mold defines the wall thickness of liner 106. The mold is rotated until the elastomeric material has partially cured. The rotation removes air bubbles from the material and creates a smooth, slippery inner surface. As liner 106 cures, it shrinks. This cure shrinkage, in combination with the mold release, allows liner 106 to slide out of the mold. Liner 106 may be of any length but should be sized so that when liner 106 is stretched and pipe 104 is located over liner 106, the ends of liner 106 extend from pipe 104 and flanges 108. Cure shrinkage should be taken into account when determining how long the mold should be. In one example, a mold 3.2 m in length resulted in a cured liner that was 3.1 m in length. Liner 106 may be of any thickness sufficient to protect inner surface 120 of pipe 104 from abrasive material. For example, liner 106 may be between about 1.5 mm and about 13 mm thick. In another example, liner 106 may be about 6.35 mm thick.

### EXAMPLE

The present invention is more particularly described in the following example that is intended as illustration only, since numerous modifications and variations within the scope of the present invention will be apparent to those skilled in the art.

Curene 442 in an amount 90% of theoretical equivalent was mixed with Andur 2-90AP and the mixture was introduced into a 3.2 m long tubular mold with a 133 mm inner diameter. The mold was rotated until the liner cured. After curing, the liner was removed. The cured liner was 3.1 m long and 6.35 mm thick. The liner was stretched 0.53 m on the tensioning frame, an elongation of 117%, with about 1,850 pounds of force. A steel pipe with an inner diameter of 127 mm, a length of 3.0 m, and a wall thickness of 9.5 mm was slid over the liner. The outer diameter of the liner had to be reduced with tension force to below 127 mm. The outer diameter of the cured liner was slightly less than 133 mm, therefore the outer diameter was reduced at least 4.7%. The tension force was removed from the liner, and the liner expanded and radially pushed against the pipe. The liner was cut with a router so that the ends of the liner were approximately equal with the ends of the pipe and had beveled edges with 45 degree angles. Beveled-end hardened inserts made of chromium carbide were inserted at each end of the pipe. The hardened inserts had beveled ends complementary to the beveled ends of the liner and met the liner at beveled lap joints. The lined pipe was installed on the deck area of a concrete pumping truck. After pumping 17,000 cubic yards, the liner exhibited no wear.

Although the present invention has been described with reference to preferred embodiments, workers skilled in the art will recognize that changes may be made in form and detail without departing from the spirit and scope of the invention. For example, although it has been described for use in pumping concrete, lined pipe 102 may also be used to transfer other abrasive materials, such as gravel and coal slurry.

1. A method of forming an elastomeric lined pipe, the method comprising:
inserting a first plug inside a first end of a cured elastomeric liner and inserting a second plug inside a second end of the cured elastomeric liner;
applying tension to the liner by pulling on the first plug to elongate the liner and reduce outer diameter of the liner from an original outer diameter without heat or a compressing device;
sliding a pipe having a first and second end over the liner so that a central portion of the liner is inside the pipe and the first and second ends of the liner extend from the first and second ends of the pipe; and
reducing the tension on the liner so that the outer diameter of the liner increases and the liner fits tightly against inner surface of the pipe.

2. The method of claim 1 and further comprising:
applying bonding adhesive to the inner surface of the pipe before sliding the pipe over the liner.

3. The method of claim 1 and further comprising:
selectively removing material from the first end and the second end of the liner to form beveled ends; and
inserting first and second beveled-end hardened inserts into the first end and the second end of the pipe, respectively, so that the hardened inserts meet the liner at beveled lap joints.

4. The method of claim 1, wherein the liner has a thickness between about 1.5 mm and about 13 mm when the liner is not under tension.

5. The method of claim 1, wherein an inner diameter of the pipe is at least about 4.7% smaller than the outer diameter of the cured elastomeric liner when the liner is not under tension.

6. The method of claim 1, wherein the cured elastomeric liner is formed of polyurethane.

7. The method of claim 6, wherein the polyurethane is formed from polytetramethylene ether glycol (PTMEG).

8. The method of claim 1, wherein the first plug has a ring and wherein the first end of the liner has a complementary groove, so that the ring fits into the groove when the first plug is inserted into the first end of the liner.

9. An elastomeric lined pipe comprising:
an abrasive material transferring pipe having a first end, a second end, an inner surface, and an inner diameter;
a cured shape memory retaining elastomeric liner having a first end, a second end, an outer surface, and an outer diameter, the inner surface of the pipe in contact with the outer surface of the liner, wherein the first end of the pipe is proximate the first end of the liner, and wherein expansion force of the liner keeps the liner in the pipe; and
a first hardened insert wherein one end of the first hardened insert meets the first end of the cured elastomeric liner.

10. The elastomeric lined pipe of claim 9, wherein the cured elastomeric liner is formed of an elastomeric material with a Die C Tear value greater than about 400 pli.

11. The elastomeric lined pipe of claim 10, wherein the cured elastomeric liner is formed of an elastomeric material with a Split Tear value greater than about 100 pli.

12. The elastomeric lined pipe of claim 9, wherein the cured elastomeric liner is formed of polyurethane.

13. The elastomeric lined pipe of claim 12, wherein the polyurethane is formed from polytetramethylene ether glycol (PTMEG).

14. The elastomeric lined pipe of claim 9, wherein the first hardened insert meets the first end of the cured elastomeric liner at a beveled lap joint.

15. The elastomeric lined pipe of claim 9 wherein the cured elastomeric liner has a thickness of about 1.5 mm to about 13 mm when the liner is not under tension.

16. The elastomeric lined pipe of claim 9 wherein the inner diameter of the pipe is between about 100 mm and about 125 mm.

17. The elastomeric lined pipe of claim 16, wherein the pipe is about 8 meters or less in length.

18. The elastomeric lined pipe of claim 9, wherein the liner is formed of an elastomeric material with an elongation value of at least 400%.

19. A method forming an elastomeric lined pipe, the method comprising:
elongating a cured elastomeric liner about a horizontal axis with tension force so that outer diameter of liner is reduced;
sliding a pipe over a central portion of the liner so that the liner is inside the pipe and first and second ends of the liner extend from the pipe;
reducing the tension force so that the outer diameter of the liner increases and liner fits tightly against inner surface of the pipe; and
inserting a beveled-end hardened insert into an end of the pipe so that the hardened insert meets the liner at a beveled lap joint.

20. The method of claim 19, wherein the liner is formed from polytetramethylene ether glycol (PTMEG).
